(19) United States
(12) Patent Application Publication
(10) Pub. No.: US 2007/0263823 A1
(43) Pub. Date: Nov. 15, 2007

(54) Automatic participant placement in conferencing

(75) Inventors: Teemu Jalava, Espoo (FI); Jussi Virolainen, Espoo (FI)

Correspondence Address: BANNER & WITCOFF, LTD., 1100 13th STREET, N.W., SUITE 1200, WASHINGTON, DC, 20005-4051, US

(73) Assignee: NOKIA Corporation, ESPOO (FI)

(21) Appl. No.: 11/393,685

(22) Filed: Mar. 31, 2006

(51) Int. Cl. H04M 3/42

(52) U.S. Cl. 379/202.01

(57) ABSTRACT

Techniques for positioning participants of a conference call in a three dimensional (3D) audio space are described. Aspects of a system for positioning include a client component that extracts speech frames of a currently speaking participant of a conference call from a transmission signal. A speech analysis component determines a voice fingerprint of the currently speaking participant based upon any of a number of factors, such as a pitch value of the participant. A control component determines a category position of the currently speaking participant in a three dimensional audio space based upon the voice fingerprint. An audio engine outputs audio signals of the speech frame based upon the determined category position of the currently speaking participant. The category position of one or more participants may be changed as new participants are added to the conference call.

### BACKGROUND

Audio conferencing has become a useful tool in business. Multiple parties in different locations can discuss an issue or project without having to physically be in the same location. Audio conferencing allows for individuals to save both time and money from having to meet together in on place.

Yet, audio conferencing has some drawbacks in comparison to video conferencing. One such drawback is that a video conference allows an individual to easily discern who is speaking at any given time. However, during an audio conference, it is sometimes difficult to recognize the identity of a speaker. The inferior speech quality of narrowband speech coders/decoders (codecs) contributes to this problem.

Spatial audio technology is one manner to improve quality of communication in conferencing systems. Spatialization or 3D processing means that voices of other conference attendees are located at different virtual positions around a listener. During a conference session, a listener can perceive, for example, that a certain attendee is on the left side, another attendee is in front, and third attendee is on the right side. Spatialization is typically done by exploiting three dimensional (3D) audio techniques, such as Head Related Transfer Functions (HRTF) filtering to produce a binaural output signal to the listener. For such a technique, the listener needs to wear stereo headphones, have stereo loudspeakers, or a multichannel reproduction system such as a 5.1 speaker system to reproduce 3D audio. In certain instances, additional cross-talk cancellation processing is provided for loudspeaker reproduction.

Perceptually, the ability of a listener to localize sound sources accurately and especially remember differences in the positions depends on the situation. For example, when two sounds from arbitrary horizontal spatial positions are played simultaneously or consecutively without a considerable delay, e.g., not exceeding a couple of seconds, a listener can relatively reliably localize the two sound sources and separate them.

In conferencing applications, certain talkers can be silent for a long period of time before starting to talk. In such a situation, the exact positioning of more than a few spatial positions can be very difficult if not impossible. In addition, the ability of a listener to memorize accurately where a certain speaker is positioned decays as time passes. The human aural sense is sensitive for comparing two stimuli to each other, but insensitive for estimating absolute values, or comparing stimuli to a memorized reference.

For example, in a 3D speech application where two speech sources are spatialized at 10 degrees span from each other on the right side of a listener, the listener can easily notice which one is closer to the center if the speakers are speaking simultaneously. However, if a period of silence separates one of the speaker's speech from the other speaker's speech, it is very difficult for the listener to identify which of the two speakers was closer to the center.

A listener can detect three spatial positions when speakers are located with one on the left, one on the right, and one in front. When more positions are used for additional speakers, the probability of confusion for a listener increases. FIG. 1 illustrates such a configuration. With respect to a listener 100, five category positions are far-left 102, left-front 104, front 106, right-front 108, and far-right 110. Listening experiments indicate that more errors are made between positions that have adjacent positions at both sides. For example, confusion occurs between positions that are at the same side, such as front-right 108 and far-right 110. In such an orientation, a far-right speaker is likely to be judged correctly to be far-right 110, but a front-right speaker can be confused to be the far-right speaker or even to a front position 106. In addition, the ability of a listener to localize sound sources to both front and back positions is relatively poor. Front-back confusion is quite a typical phenomenon in 3D audio systems.

Another problem associated with audio conferencing is the situation when more than one person happens to speak at the same time. Push-to-Talk over Cellular (PoC) is a special subcase of conferencing that helps address this problem since only one participant can speak at any given time. FIG. 2 illustrates one such example 200. In example 200, six participants, 221-226, to a conference call are located in one location, such as a conference room of an office. Each participant communicates with a seventh participant, separate from the others, by way of a telephone 230. In this example, telephone 230 may have a speaker phone capability allowing everyone to hear from one speaker. In some manner, whether wired, wirelessly, or both, signals corresponding to audio communication are transmitted to and received from the seventh participant via transmission path 240. In example 200, the seventh participant has a mobile terminal 250 with a display screen 252. PoC technology provides information 261 about who is speaking on the display screen 252 of the mobile terminal 250 of the listener, e.g., the seventh participant. However, if the seventh participant uses a headset and the mobile terminal 250 is in a pocket or otherwise out of vision, the information 261 displayed in the display screen 252 is not enough. In such a case, although the information 261 may identify the current speaker, such as participant 221, the listener cannot easily discern the identity of the speaker. In the above example, an identity detection algorithm may be used to differentiate between the six participants, 221-226. In one variation, the six participants 221-226 may each use separate devices in different locations. Each device may transmit the participant identification corresponding to the device user without the need for an identity detection algorithm. Although such a scenario facilitates participant identification, the aforementioned issues of discerning the identity of the speaker still exist.

Applying 3D audio technologies, attendees to an audio conference can be spatialized to different virtual positions around the listener to make the identity detection easier, since the listener can associate a certain speaker to a specific location. However, there is a perceptual limit of how many locations can be used. When talkers that have similar kinds of voices are placed near to each other, despite the spatial representation, the listener might face ambiguous situations. Thus, monaural cues may be used to differentiate speakers in such situations. However, monaural cues are not as effective when the monophonic mix contains voices that are similar in sound versus if the mix includes voices that are substantially different. For example, a monophonic mix including two male talkers would be more difficult to process than a mix consisting of a male speaker and a female speaker. In addition, prior systems for spatializing to virtual positions either try to map real world placements to the 3D audio space or ask a user to place the participants. The placement information is then delivered to each participant so that each participant has the same audio view. Real world or user created placements may lead to ineffective systems that provide no real benefits to speaker recognition as speakers can be too close to each other.

### SUMMARY

There exists a need for an automatic placement of audio participants into a 3D audio space for maximizing a listener's ability to detect the identity of a talker and for maximizing intelligibility during simultaneous speech by multiple speakers. Aspects of the invention calculate feature vectors that describe a speaker voice character for each of the speech signals. The feature vector, also referred to as a voice fingerprint, may be stored and associated to an ID of a speaker. A position for a new speaker is defined by comparing the voice fingerprint of the new speaker to the voice fingerprints of the other speakers, and based on the comparison, a perceptually best position is defined. When the difference in voice characters is taken into account in the positioning process, a perceptually more efficient virtual communication environment is created with fewer interruptions and confusions during the communication. Additionally, headtracking may be used to compensate for head rotations to make a sound scene naturally stable resolving front-back confusion.

Aspects of the invention provide a system where participants are positioned automatically to optimal places without any user input. Aspects of a system for positioning include a client component that extracts speech frames of a currently speaking participant of a conference call from a transmission signal. A speech analysis component determines a voice fingerprint of the currently speaking participant based upon any of a number of factors, such as a pitch value of the participant. A control component determines a category position of the currently speaking participant in a three dimensional audio space based upon the voice fingerprint. An audio engine outputs audio signals of the speech frame based upon the determined category position of the currently speaking participant. The category position of one or more participants may be changed as new participants are added to the conference call.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an example configuration of five category positions that a listener can memorize and separate;

FIG. 2 illustrates an example of a conventional conference call;

FIGS. 3A-3C illustrate examples of a placement order of one to three other participants in a conference call in accordance with at least one aspect of the present invention;

FIGS. 4A-4E illustrate examples of a placement order of four to five participants in a conference call in accordance with at least one aspect of the present invention;

FIG. 5 illustrates an example of dynamic positioning of participants in a conference call in accordance with at least one aspect of the present invention;

FIGS. 6A-6G illustrate other examples of a placement order of four to five participants in a conference call in accordance with at least one aspect of the present invention;

FIG. 7 illustrates an example of a placement order of a sixth participant in a conference call in accordance with at least one aspect of the present invention;

FIG. 8 illustrates an example of positioning of participants in a conference call in accordance with at least one aspect of the present invention;

FIG. 9 is a block diagram of an illustrative system for placing participants in a placement order in accordance with at least one aspect of the present invention;

FIG. 10 is a flowchart of an illustrative example of a method for placing participants of a conference call into a placement order in accordance with at least one aspect of the present invention; and

FIG. 11 is a flowchart of another illustrative example of a method for placing participants of a conference call into a placement order in accordance with at least one aspect of the present invention.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

Aspects of the present invention describe a system for sound source positioning in a three-dimensional (3D) audio space. Systems and methods are described for calculating feature vectors describing speaker's voice characters for each speech signal. The feature vector may be stored and associated to a participant's ID. A position for a new participant may be defined by comparing the voice fingerprint of the new participant to the fingerprints of the other participants and based on the comparison, a perceptually best position for the new participant may be defined. Such systems and methods help improve speaker recognition in an audio conference. Further, positioning is not limited to front positions but may also include back positions. In particular, headtracking systems may take advantage of back positions.

Optimal configurations for the participants depending on how many participants are attending to the conference call may be defined for a listener, e.g., first participant. An order for mapping the other participants to particular positions may also be defined. When there are more than five other participants in a conference call, such as six other participants, five may be mapped to the five category positions described above, and a sixth may be grouped with one of the five. As such, there can be several talkers in the same position. In such a configuration, it is easier for a listener to memorize which two participants are mapped in the same position than to attempt to separate positions that are near each other. For example, male and female voices may be positioned in the same space because their voice fingerprints are typically very different from each other. On the other hand, voices with similar voice fingerprints may be positioned far way from each other. The order of mapping participants to positions may be optimized to provide perceptually an efficient representation. A new participant is mapped to a position in which a listener can distinguish most easily from the other positions already in use.

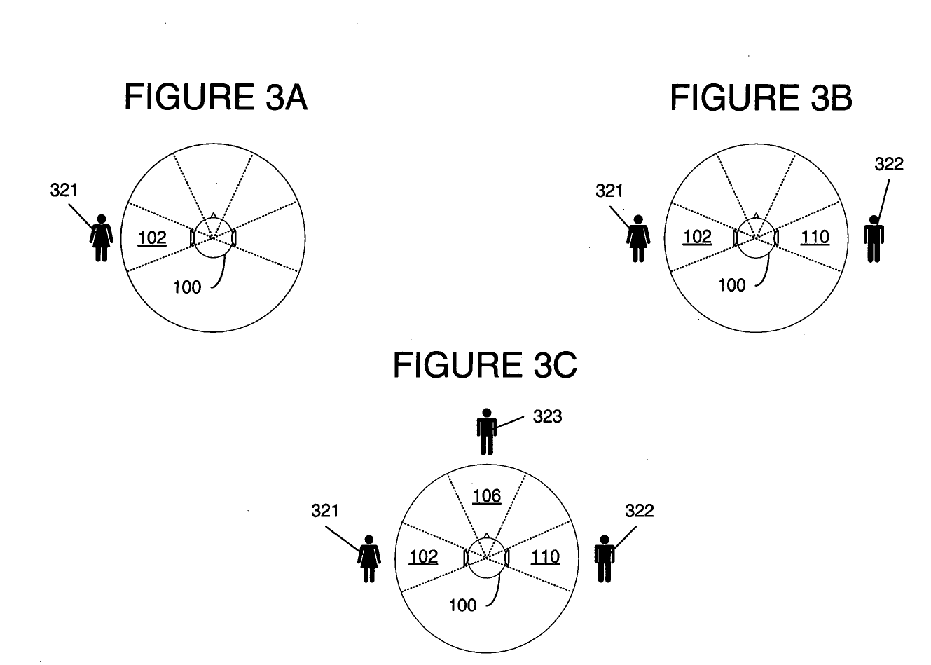

The optimal configuration and order of placing participants to locations may depend on how many participants are in the group. FIGS. 3A-3C illustrate examples of a placement order of one to three other participants in a conference call in accordance with at least one aspect of the present invention. As shown in FIG. 3A, if there is one other participant to a conference call with a listener 100, the one other participant 321 may be automatically placed into a default position, such as far-left category position 102. Alternatively, the first participant default position may be another position, such as front position 106. FIG. 3B builds upon the example of FIG. 3A. In FIG. 3B, if there are two other participants to a conference call with a listener 100, the second other participant 322 may be automatically placed into a second participant default position, such as far-right category position 110. Alternatively, the second participant default position may be another position. Finally, FIG. 3C builds upon the example of FIG. 3B. FIG. 3C illustrates a conference call with a listener 100 and three other participants, 321-323. As shown, the third other participant 323 may be automatically placed in a third participant default position, such as front category position 106. For the examples shown in FIGS. 3A-3C, when a participant is placed to a certain position, the position is constant and does not need to be changed later. Such a configuration helps a listener to learn where each participant is placed.

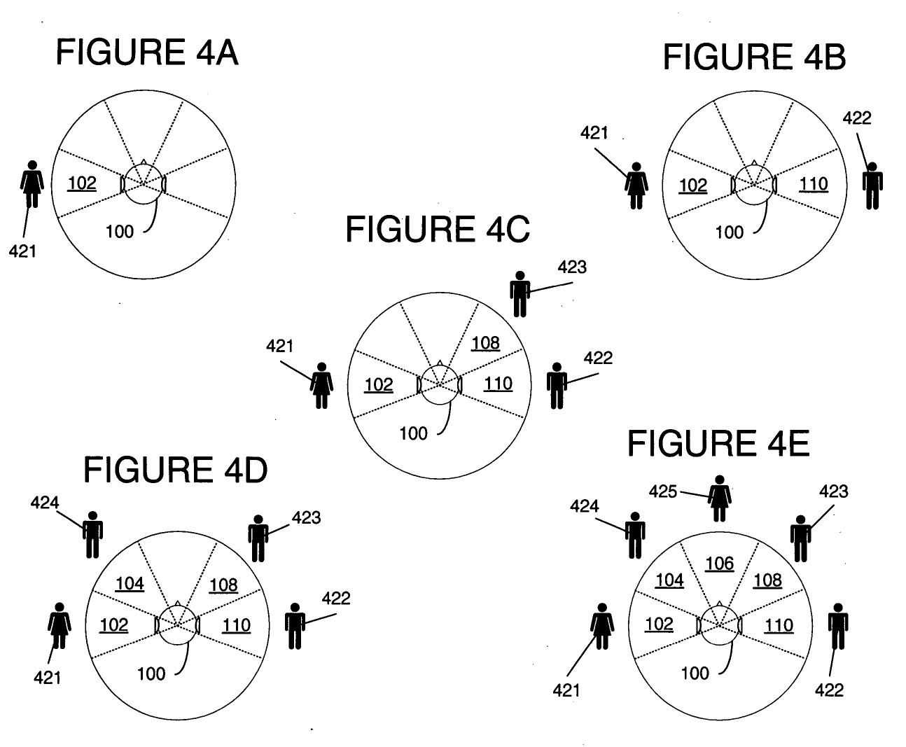

FIGS. 4A-4E illustrate examples of a placement order of four to five participants in a conference call in accordance with at least one aspect of the present invention. FIGS. 4A-4C are similar to FIGS. 3A-3C for placing three other participants with a listener. FIGS. 4A-4C illustrate placement of the other participants 421, 422, and 423 into participant category positions far-left 102, far-right 110, and front-right 108, respectively. As opposed to placing the third other participant into front category position 106, as shown in FIG. 3C, the third other participant 423 may be placed in front-right category location 108 as shown in FIG. 4C.

FIG. 4D illustrates the addition of a fourth other participant 424. Upon identification of a fourth other participant 424 to a conference call, the fourth other participant 424 is placed in front-left category position 104. In the configuration with five other participants, as shown in FIG. 4E, a fifth other participant 425 to the conference call may be placed in front category position 106. When there are more than five other participants, as described below, the participants may be placed to the same five category positions using the same method for placement. It should be understood by those skilled in the art that any of a number of different placement orders may be configured. For example, a first other participant 421 may be placed in front category position 106, a subsequent participant 422 in far-left category position 102, another subsequent participant 423 in far-right category position 110, another subsequent participant 424 in front-left category position 104, and a final subsequent participant 425 in front-right category position 108. In another example, male participants may be positioned to left side of a listener and female participants to a right side. While any number of category positions may be defined and used, five positions provide a perceptually efficient solution.

Aspects of the present invention also allow for a change in positioning of one or more participants as additional participants are identified and added to the conference call. FIG. 5 illustrates an example of dynamic positioning of participants in a conference call in accordance with at least one aspect of the present invention. For example, when a new participant starts to speak for the first time, he/she may first be positioned to the front category position 106 and then immediately 3D panned to a target category position, such as far-right. FIG. 5 illustrates a conference call where a listener 100 and two other participants, 521 and 522, have a new participant 523 identified and added to the conference call. As shown, the first two participants, 521 and 522, have been placed in far-left category position 102 and far-right category position 110, respectively. When new participant 523 speaks for the first time, he may initially have a start position in front category position 106 and then 3D pan to a third other participant category position, such as front-right category position 108. The 3D panning may be performed either smoothly or discretely.

The duration of 3D panning may be based upon time, words, or other criteria. 3D panning may place an initial word or words of a speaker with respect to a start position and then place subsequent words with respect to an end position. Alternatively, 3D panning may place an initial word of words of a speaker with respect to a start position and then move positions, by more or more words to an end position. For example, when a first participant initially speaks, he/she may be placed in front category position 106 for 1 second and then be moved to far-left category position 102 over a span of 2 seconds. During that span of time, the first participant may be placed in front-left category position 104 for 1-2 seconds prior to front category position 102, the end position.

As described above, the panning duration could be a few seconds, such as 2-5 seconds. In one embodiment, 3D panning may be done only when a speaker is talking so that a listener can perceive the movement and the end position. In such a configuration, when a source appears to front category position 106, it indicates that a new speaker has been identified and added to the conference call. For such a configuration, front category position 106 may be configured so that it is not used as an end position for any participant. Using dynamic positioning also allows some time for feature extraction processing and analysis of voice fingerprints between different voices as described below.

Push-to-Talk over Cellular (PoC) technology allows a PoC listener to always know the active participants of a PoC conference call that the listener has joined. Information about PoC conference calls may be stored in a PoC server that is accessible via extensible Markup Language (XML) Configuration Access Protocol (XCAP). In communication with PoC technology, a listener may experience considerable delay before a speech signal reaches him/her. When a new participant speaks for the first time, an additional delay, such as 2 seconds, may be added by buffering the incoming speech signal at a receiving terminal device of the listener. This additional delay makes it possible to give extra time for speech parameter feature extraction and analysis of differences in participants' voice characters. As such, the system may position a new speech signal directly to an end position without positioning it at first to the front category position 106 and then 3D panning the speech signal to the end position. Adding the extra delay only when the new participant speaks the first time will not deteriorate considerably the quality of communication.

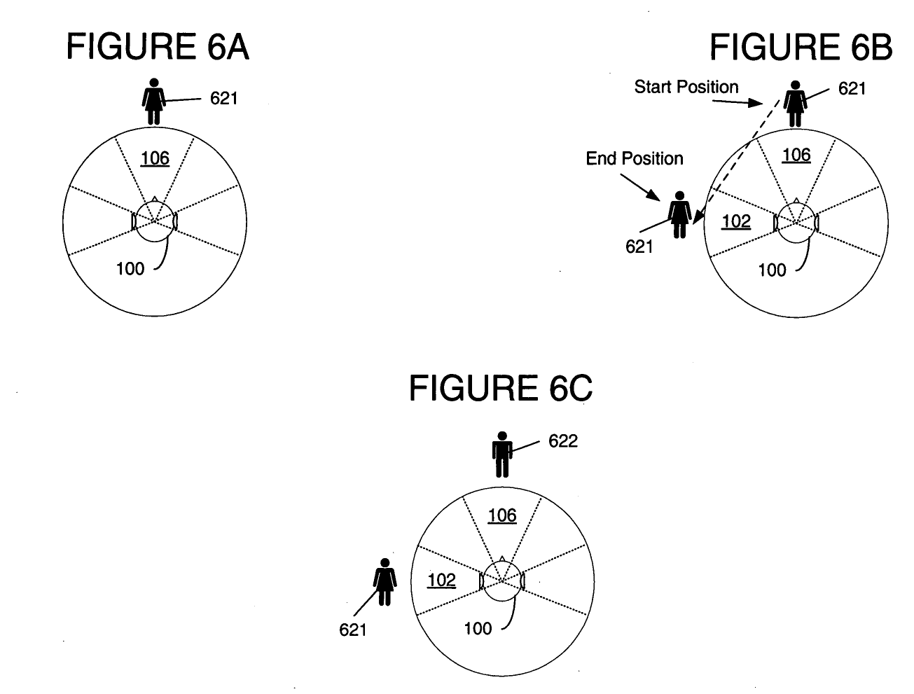

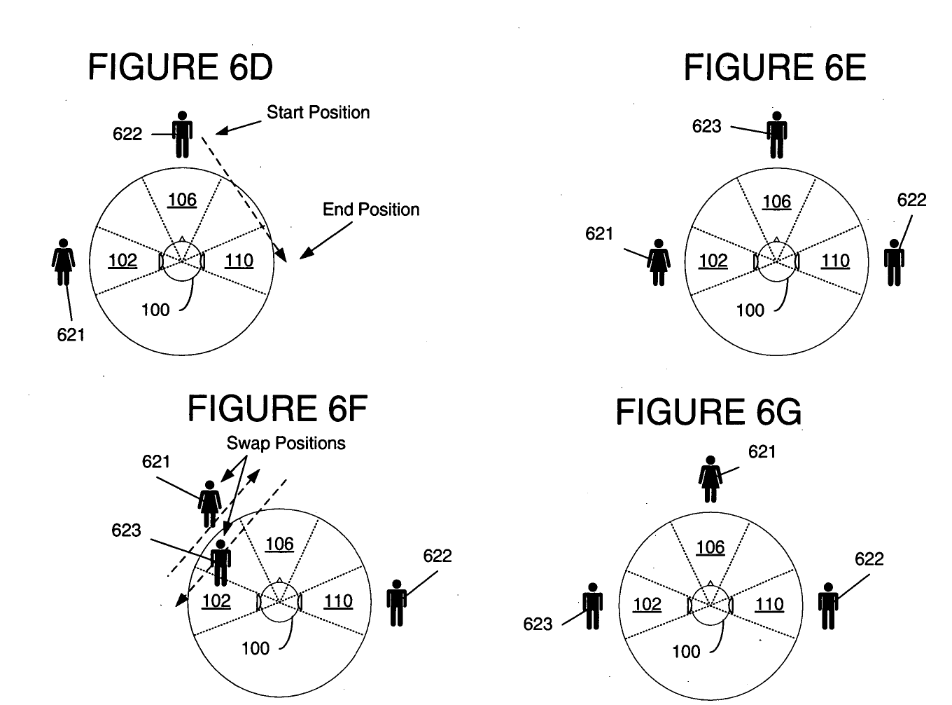

FIGS. 6A-6G illustrate other examples of a placement order of four to five participants in a conference call in accordance with at least one aspect of the present invention when dynamic positioning is utilized. FIG. 6A illustrates when a listener 100 first encounters a source at front category position 106. In this example, a female participant 621 has been identified based on the pitch value of participant 621's voice. As this is the first time that participant 621 has spoken, the system places the speech signal corresponding to participant 621 in front category position 106. FIG. 6B illustrates the movement of female participant 621 to an end position, which is far-left category position 102 in this example. The dashed line representation from start position to end position illustrates the 3D panning of the speech signal of female participant 621. The 3D panning may occur over a time period, such as 3 seconds. Now, listener 100 knows that a female voice from far-left category position 102 corresponds to female participant 621. For example, from FIG. 6A-6B, participant 621 enters the conference call and says, “Hello, this is Amy Anderson.” The words “Hello” and “this” may be heard by the listener 100 from front category position 106. Then, the system 3D pans the speech signal so that the words “is” and “Amy” may be heard by the listener 100 from front-left category 104. Finally, the word “Anderson”, and all subsequent words by participant 621, may be heard by listener 100 from far-left category position 102. Again, the panning of the speech signal may be either smooth or discrete according to system specifications and user preferences.

Proceeding to FIG. 6C, a male participant 622 has been identified since he has spoken for the first time. As this is the first time that participant 622 has spoken, the system places the speech signal corresponding to participant 622 in front category position 106 as shown. FIG. 6D illustrates the movement of male participant 622 to an end position, which is far-right category position 110 in this example. The dashed line representation from start position to end position illustrates the 3D panning of the speech signal of male participant 622. Again, the 3D panning may occur over a time period, such as 3 seconds. Now, listener 100 knows that a female voice from far-left category position 102 corresponds to participant 621 while a male voice from far-right category position 110 corresponds to participant 622.

As shown in FIG. 6E, a second male participant 623 has been identified. As this is the first time that participant 623 has spoken, the system places the speech signal corresponding to participant 623 in front category position 106 as shown. In one example, such as shown in FIG. 4C, the second male participant may be placed in front-right category position 108. However, in such a case, optimal performance and efficiency may be gained by changing the position of the participants. As shown in FIG. 6F, the system may be configured to swap the positions of one or more participants in the conference call. In FIG. 6F, female participant 621 is moved to front category position 106 and the second male participant 623 is moved to far-left category position 102. The dashed line representations from start positions to end positions illustrate the change of positioning of female participant 621 and male participant 623. Now, as shown in FIG. 6G, listener 100 knows that a female voice from front category position 106 corresponds to female participant 621, a male voice from far-left category position 102 corresponds to male participant 623, and a male voice from far-right category position 110 corresponds to male participant 622.

In one embodiment, when all category positions are already in use, such as when five other participants to a conference call have been identified, a new participant may be placed to a category position where the participant corresponding to that category position has a greatest different voice character when comparing the new participant voice character to each of the five other participant's voice characters. Thus, when two participants are placed to the same category position, a listener stills identifies them individually.

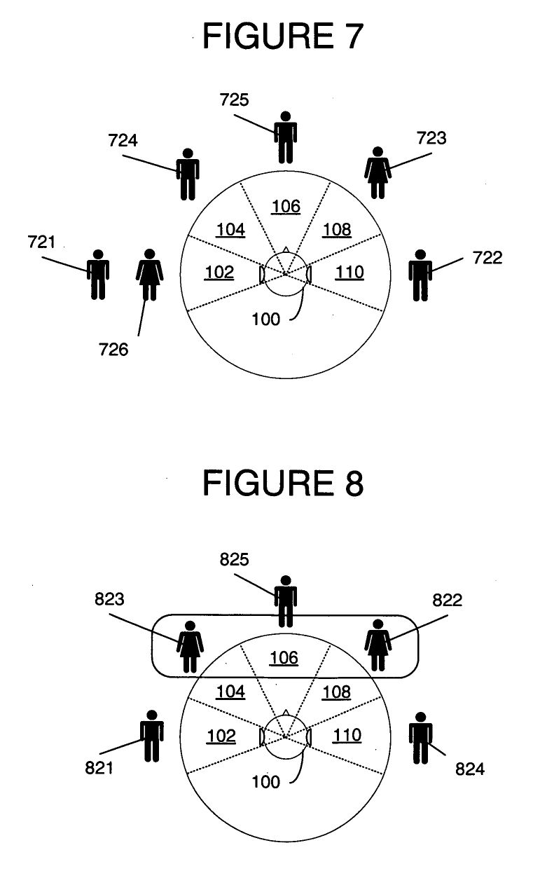

FIG. 7 illustrates an example of a placement order of a sixth participant in a conference call in accordance with at least one aspect of the present invention. Participants 721-725 are singly placed in category positions far-left 102, far-right 110, front-right 108, front-left 104, and front 106, respectively. When a sixth participant 726 speaks for the first time, participant 726 is placed to one of the five category positions where a participant with a different voice pitch is. As shown, participant 726 may be a female participant with a higher voice pitch. The system may compare the voice fingerprint, including a pitch value, of female participant 726 with each of the other participants 721-725 and determine that male participant 721 has the lowest voice pitch. As such, the system may place female participant 726 in far-left category position 102. It should be understood by those skilled in the art that a number of different and/or additional characters may be used for comparison purposes as described below and that the present invention is not so limited to the pitch of a participant's voice.

FIG. 8 illustrates another example of positioning of participants in a conference call in accordance with at least one aspect of the present invention. The system may be used to maximize the ability of listener 100 to separate adjacent positions. For example, participants with the three lowest pitch values may be placed to far-left, far-right, and front category positions, while those participants with the two highest pitch values may be placed to front-right and front-left category positions. FIG. 8 illustrates such an example. Male participants 821, 824, and 825 may be initially positioned and/or at a later time dynamically positioned in far-left 102, far-right 110, and front 106 category positions, respectively. Female participants 822 and 823 may be initially positioned and/or at a later time dynamically positioned in front-right 108 and front-left 104 category positions, respectively. This way listener 100 may notice more easily whether the speaking participant was located at front-right 108 or far-right 110 category position.

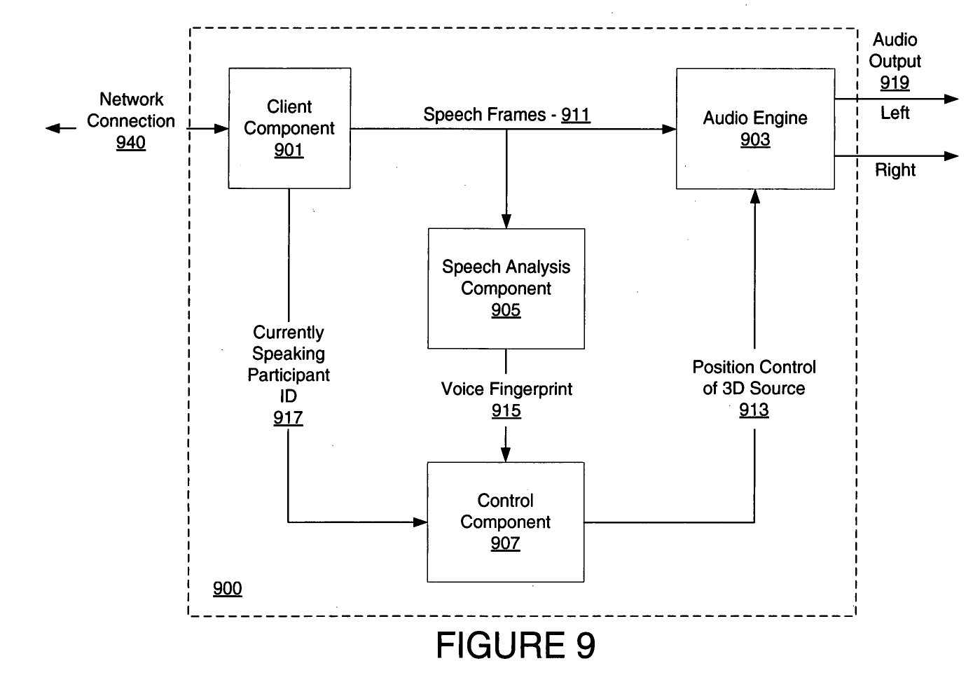

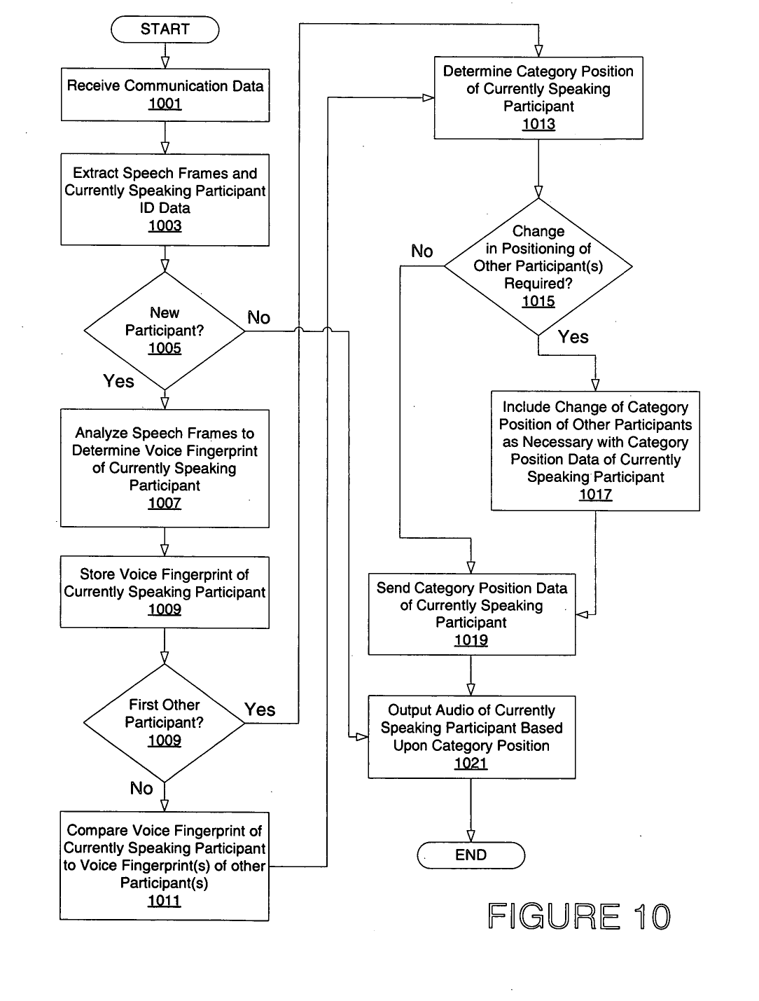

Push-to-Talk over Cellular (PoC) technology allows a PoC listener to always know the active participants of a PoC conference call that the listener has joined. Information about PoC conference calls may be stored in a PoC server that is accessible via extensible Markup Language (XML) Configuration Access Protocol (XCAP). FIG. 9 is a block diagram of an illustrative system for placing participants in a placement order in accordance with at least one aspect of the present invention. The system illustrated in FIG. 9 may be included within one or more components of a mobile terminal 900 of a listener.

Network connection 940 represents the connection to one or more communication networks between a mobile terminal 900, a computer, and/or another end terminal device. Mobile terminal 900 is shown to include a client component 901, an audio engine 903, a speech analysis component 905, and control component 907. One or more components, such as client component 901 and control component 907, may be components. Network connection 940 is operatively connected to mobile terminal 900 through client 901. Speech frames 911 from a conference call are sent to audio engine 903 and to speech analysis component 905. Voice fingerprint data 915 identified by the speech analysis component 905 is sent to the control component 907. The ID 917 of a currently speaking participant is sent from the client component 901 to control component 907. Data 913 corresponding to position control of the 3D source is sent from control component 907 to audio engine 903. Finally, audio engine 903 outputs audio 919 via at least a left and right speaker. Specific information re each component and data representation is described below.

Network connection 940 allows transmission and reception of speech signals in addition to other data. Included in the transmission are speech frames 911 of a current conference call, data corresponding to the active participants in the current conference call, and information 917 identifying who the currently speaking participant is at any given time and a total number of participants. The speaker identification may include a stream identifier, channel number, additional data in the frame or some other form of inband signaling. In one or more configurations, information 917 identifying the current speaking participant is determined and sent by a remote server (not shown) to client component 901. The remote server may further embed the identity of the current speaking participant in a signaling portion of communication data transmitted to client component 901. Such information may be taken from the TBCP (Talk Burst Control Protocol) and passed to control component 907 through client component 901. Changes in the number of active participants, such as the addition of a speaker and/or the drop of a participant from the conference call, are also passed to control 907.

Speech frames 911 include the data corresponding to the spoken words of a currently speaking participant. Speech frames 911 are eventually outputted as audio data and are thus sent to audio engine 903. Speech frames 911 are also sent to speech analysis component 905. One or more characters of speech of a participant are analyzed to determine a voice fingerprint 915 of the currently speaking participant. As used herein, a voice fingerprint may also be referred to as a feature vector. The voice fingerprint 915 is then passed to control component 907. Various methods and manners for determining a character, such as a pitch, of speech of a speaker and placement of individuals in a conference call are well known in the art. U.S. Pat. No. 6,850,496 to Knappe et al. is one such example for placement of individuals in a conference call. In one example, the pitch value may be retrieved or extracted from a speech decoder directly. Other voice features may include intensity, positions of formant frequencies, short-time spectrum, linear prediction coefficients and mel frequency cepstral coefficients (MFCC).

Control component 907 is configured to control the orientation of positions of the participants with respect to a listener at mobile terminal 900 and any necessary change in the positions of the participants. Control component 907 takes the voice fingerprint 915 and compares the voice fingerprint to other previously determined voice fingerprints 915 of other participants in the current conference call. The voice fingerprint 915 of the currently speaking participant is then stored and associated with the currently speaking participant ID 917. In one embodiment, the calculated voice fingerprint 915 may be stored to a phone book or other storage device of the listener at mobile terminal 900. Then, control component 907 determines a category position for placement of the currently speaking participant. The determined category position is sent as a data signal 913 to audio engine 903. With the category position data 913, audio engine 903 outputs audio 919 of the speech frames 911 at the specified 3D specialization position.

For example and in accordance with the illustrated example of FIGS. 6A-6G, a first speaking participant 621 speaks. The speech frames 911 of participant 621 are passed through client component 901 to speech analysis component 905 and audio engine 903. Speech analysis component 905 obtains a voice fingerprint 915 of participant 621 based upon any of a number of different voice characters, such as pitch, tone, and volume. One option is to analyze the pitch of the speech from the parameters in the coded domain of the speech frames 911 or fetch a pitch value directly from a decoder. Several other features from the speech frames 911 may be extracted and used to define the perceptual dissimilarity between the voices of participants. The voice fingerprint 915 of participant 621 is passed to control 907. The currently speaking participant ID 917, passed from client component 901 to control component 907, is associated with voice fingerprint 915 of participant 621. Because participant 621 is the first speaker, no comparison with other voice fingerprints of other participants is necessary. Control component 907 then sends position control data 913 corresponding to the specified category position for participant 621. In this example, the category position is front category position 106. In addition, as the examples described in FIGS. 6A-6E illustrate panning, position control data 913 may further include an end category position for participant 621. Corresponding to FIG. 6B, audio engine 903 takes the speech frames 911 of participant 621 and the category position data 913 to output audio 919 of participant 621 and pans the audio output 919 from front category position 106 to far-left category position 102. In such an example, audio engine 903 may output audio 919 equally across the left (L) and right (R) speakers of a headset of the listener at the mobile terminal 900 for one second and then pan the audio output 919 by increasing the output to the left audio and decreasing the output to the right audio over a three second time period. Thus, a listener at mobile terminal 900 knows that participant 621 is located at a far-left category position 102 for subsequent speeches.

Now, corresponding to FIG. 6C, participant 622 speaks for the first time. The speech frames 911 of participant 622 are passed through client component 901 to speech analysis component 905 and audio engine 903. Speech analysis component 905 obtains a voice fingerprint 915 of participant 622 based upon any of a number of different voice characters, such as formant, pitch, tone, and volume. The voice fingerprint 915 of participant 622 is passed to control 907. The currently speaking participant ID 917, passed from client component 901 to control component 907, is associated with voice fingerprint 915 of participant 622. Because participant 622 is the second speaker, a comparison of the voice fingerprint of participant 621 and voice fingerprint 915 of participant 622 is made. If necessary, the position of participant 621 and/or 622 may be changed in response to the comparison of voice fingerprints 915. Control component 907 then sends position control data 913 corresponding to the specified category position for participant 622, and, if necessary 621. In this example, the category position for participant 622 is front category position 106. In addition, position control data 913 may further include an end category position for participant 622. Corresponding to FIG. 6D, audio engine 903 takes the speech frames 911 of participant 622 and the category position data 913 to output audio 919 of participant 622 and pans the audio output 919 from front category position 106 to far-right category position 110. In such an example, audio engine 903 may output audio 919 equally across the left (L) and right (R) speakers of a headset of the listener at the mobile terminal 900 for one second and then pan the audio output 919 by increasing the output to the right audio and decreasing the output to the left audio over a three second time period. Thus, a listener at mobile terminal 900 knows that participant 621 is located at a far-left category position 102 and that participant 622 is located at a far-right category position 110 for subsequent speeches. In one or more 3D audio systems, the level between the channels and the delay between the channels may also affect the position of the sound source. Thus, panning in one or more 3D audio systems may also factor in these differences in level and delay.

Finally, corresponding to FIG. 6E, participant 623 speaks for the first time. Again, the speech frames 911 of participant 623 are passed through client component 901 to speech analysis component 905 and audio engine 903. Speech analysis component 905 obtains a voice fingerprint 915 of participant 623. The voice fingerprint 915 of participant 623 is passed to control 907. The currently speaking participant ID 917 is associated with voice fingerprint 915 of participant 623. Because participant 623 is the third speaker, a comparison of the voice fingerprint of participants 621 and 622 and voice fingerprint 915 of participant 623 is made. If necessary, the position of participant 621, 622, and/or 623 may be changed in response to the comparison of voice fingerprints 915. In the example of FIG. 6F, control component 907 may determine that the position of participants 621 and 623 are to be changed. Control component 907 then sends position control data 913 corresponding to the specified category position for participant 623, and, if necessary 621 and/or 622. In the example corresponding to FIG. 6E, the category position for participant 623 is front category position 106. In addition, position control data 913 may further include an end category position for participant 623 and any necessary change of position for other participants. Corresponding to FIG. 6F, audio engine 903 takes the speech frames 911 of participant 623 and the category position data 913 to output audio 919 of participant 623 and panning the audio output 919 from front category position 106 to far-left category position 102. In such an example, audio engine 903 may output audio 919 equally across the left (L) and right (R) speakers of a headset of the listener at the mobile terminal 900 for one second and then pan the audio output 919 by decreasing the output to the right audio and increasing the output to the left audio over a three second time period. Similarly, a record may be kept so that future speech of participant 621 is outputted at front category position 106. Thus and in accordance with FIG. 6G, a listener at mobile terminal 900 knows that participant 621 is located at a front category position 106, participant 622 is located at a far-right category position 110, and that participant 623 is located at a far-left category position 102 for subsequent speeches. Talkers that sound similar can be placed to far from each other to minimize the possibility that a listener incorrectly detects the identity of the speaking participant. This can be advantageous especially when more than one talker is placed to the same category position or near to each other.

It should be understood by those skilled in the art that there may occur other instances in which a need to change one or more positions of participants arises. For example with respect to FIG. 7, after a certain amount of time, participant 722 may drop off of the conference call, whether purposefully or inadvertently. Such may occur when participant 722 must leave for another appointment. If such an event occurs, in accordance with aspects of the present invention, one or more of the other participants may be positioned into a different category position. For example, because there are currently two participants, 721 and 726, at far-left category position 102, participant 721 may be repositioned to be located at far-right category position 110 since, with participant 722 dropping, the category position is unused. Aspects of the invention provide the flexibility to control positioning in a conference call including swapping positions of two talkers, if necessary. Other conditions and events may occur that warrant a change in positions of one or more participants. The examples described herein are illustrative and do not limit the present invention.

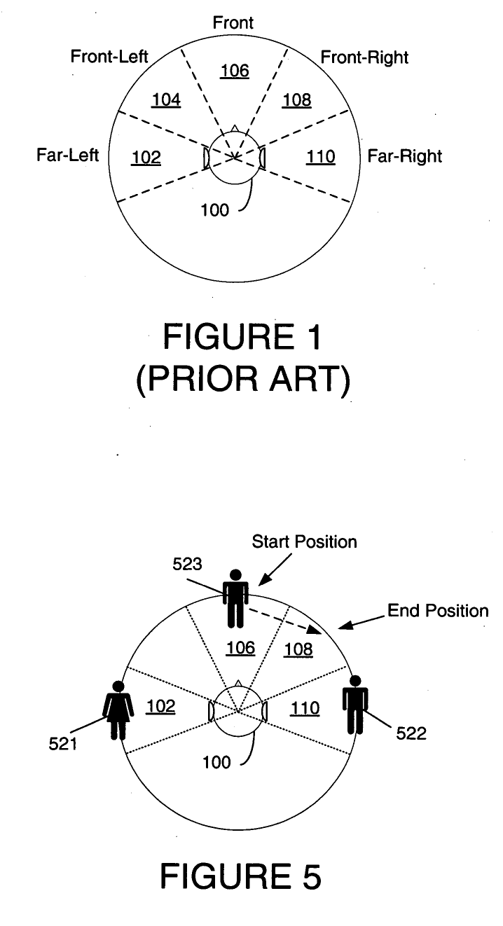

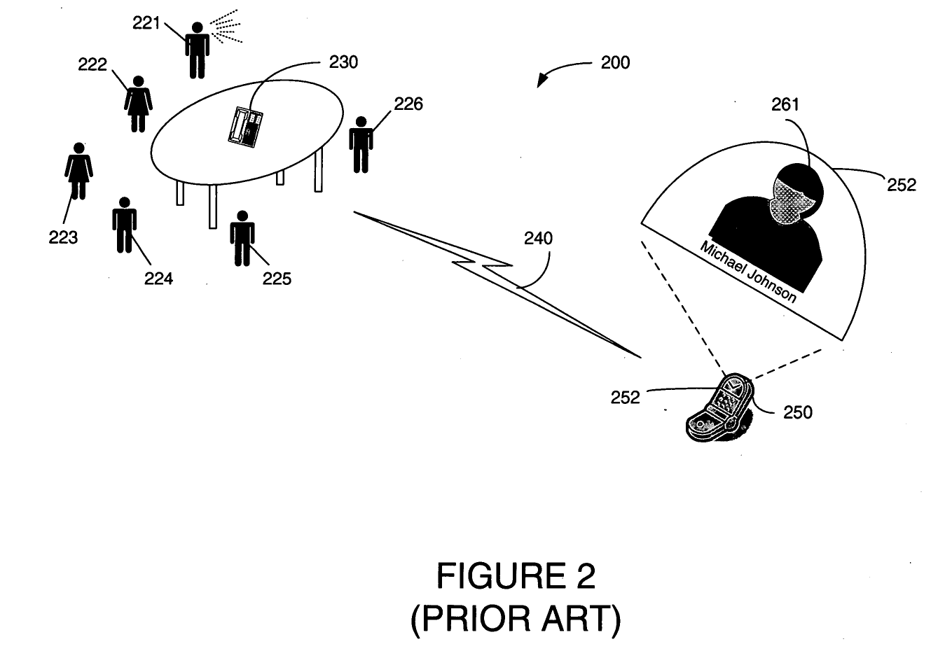

FIG. 1 0 is a flowchart of an illustrative example of a method for placing participants of a conference call into a placement order in accordance with at least one aspect of the present invention. The process starts at step 1001 where communication data is received. Communication data may be a signal that includes speech frames of a currently speaking participant and identification of that participant. The communication data may be in mono format (as in PoC systems) or, alternative or additionally, include a multichannel signal. At step 1003, the speech frames and currently speaking participant ID data are extracted from the communication data. Proceeding to step 1005, a determination is made as to whether the currently speaking participant is a new participant to the conference call, i.e., his/her voice fingerprint has not yet been previously determined and associated with the ID data. If the participant is not new, i.e., he/she has a voice fingerprint already associated with the ID data, audio is outputted at step 1021 of the currently speaking participant based upon a previously determined category position for that participant and the process ends. Else, if the participant is a new participant to the conference call in step 1005, the process moves to step 1007.

At step 1007, the speech frames are analyzed to determine a voice fingerprint for the currently speaking participant. As described above, any of a number of different characters of the voice of a participant may be analyzed to determine the fingerprint. For example, the pitch of the speech of the participant may be analyzed. At step 1009, the determined voice fingerprint is associated with the ID data of the currently speaking participant and stored. A determination is then made as to whether the currently speaking participant is a first participant other than the listener. If not, the voice fingerprint of the currently speaking participant is compared to the voice fingerprint(s) of other previously determined participants in order to place the participants in a defined order for ease of understanding by the listener. The process then proceeds to step 1013. If the currently speaking participant is a first other participant in step 1009, the process proceeds directly to step 1013.

A category position of the currently speaking participant is determined at step 1013. In one example, it may be determined that the currently speaking participant be positioned in the front category position with respect to the listener. At step 1015, a determination is made as to whether a change in the spatial positioning of one or more other participants, aside from the currently speaking participant, is required. If yes, the method moves to step 1017 where the change of category position(s) of the other participant(s) is included with the category position data of the currently speaking participant as necessary. The process then proceeds to step 1019. If a change in positioning of one or more other participants is not required in step 1015, the process proceeds directly to step 1019.

At step 1019, category position data of the currently speaking participant is sent to an audio engine. Among other tasks, the audio engine performs 3D audio processing of input signals according to location control data including mixing the signals into a binaural signal. As described above, this category position data may also include category position data regarding one or more other participants. Finally, at step 1021, audio is output of the currently speaking participant based upon the determined category position of that participant and the process ends.

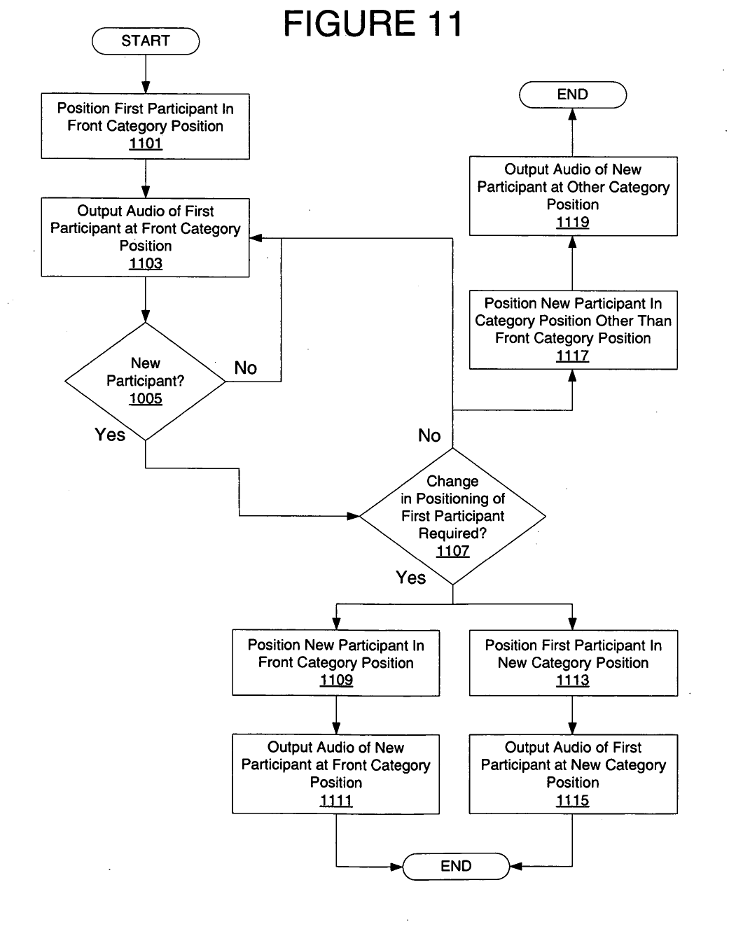

FIG. 11 is a flowchart of another illustrative example of a method for placing participants of a conference call into a placement order in accordance with at least one aspect of the present invention. The process starts at step 1101 where a first participant to a conference call other than the listener is positioned in the front category position with respect to the listener. At step 1103, audio of the first participant is outputted at the front category position. Proceeding to step 1005, a determination is made as to whether a new participant has been identified. If not, the process proceeds back to step 1103. Else, if a new participant has been identified in step 1105, the process proceeds to step 1107.

At step 1107, another determination is made as to whether a change of positioning of the first participant is required. For example, it may be determined that the first participant should be positioned in a different category position in light of the new participant entering the conference call. If a change in positioning of the first participant is required in step 1107, the process moves to step 1109 where the new participant is positioned in the front category position with respect to the listener, and, at step 1111, audio of the new participant is output at the front category position. In addition, the position of the first participant is changed to a new category position at step 1113, and, at step 1115, future speech by the first participant is output at the new category position before the process ends. If no change is required in step 1107, the process moves to steps 1103 and 1117.

At step 1117, the new participant is positioned in a category other than the front category position with respect to the listener, and, at step 1119, audio of the new participant is output at the other category position. In addition, since the position of the first participant has not changed, future speech by the first participant is output at the front category position at step 1103. It should be understood by those skilled in the art that other positions and/or configurations may be made with respect to one or more participants in accordance with the methods described herein and that the present invention is not so limited to the illustrative examples provided.

This invention can be used together with various PoC standards as known in the art including Open Mobile Alliance (OMA) specifications, and Phase 1 and Phase 2 standards. Specifically, Phase 1 standards include a collection of six specifications including Requirements, Architecture, Signaling Flows, Group/List Management and two User-Plane specifications (Transport and GPRS). Phase 2 extends the Phase 1 standard adding three new specifications including Network-to-Network Interface (NNI), Presence and Over-the-Air Provisioning. The foundation of the OMA standard is based on Phase 1 and Phase 2 standards and represents a natural evolution from Phase 1 and Phase 2. Information regarding the OMA standard can be found at the OMA website and associated locations. It should be understood by those skilled in the art that aspects of the present invention are not limited to PoC applications. Previously described principles may be applied to general 3D teleconferencing that allows simultaneous speech. Embodiments of the present invention may include client based systems that are independent of other end terminals and/or a server between end terminals. Aspects may be implemented and integrated to existing PoC listeners. A user interface may be included to improve the communication if required. Aspects of the present invention may also be implemented as a part of a conference bridge based system.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A device for positioning participants of a conference call in a three dimensional (3D) audio space, the device comprising:
a client component configured to extract speech frames of a currently speaking participant from a transmission signal;
a speech analysis component configured to determine a voice fingerprint of the currently speaking participant from the speech frames;
a control component configured to determine a category position of the currently speaking participant in the 3D audio space based upon the voice fingerprint; and
an audio engine configured to process and output audio signals of the speech frames based upon the determined category position of the currently speaking participant.

2. The device of claim 1, wherein the client component is further configured to extract an identification (ID) of the currently speaking participant from the transmission signal.

3. The device of claim 2, wherein the control component is further configured to associate the voice fingerprint with the ID.

4. The device of claim 3, wherein the control component is further configured to store the voice fingerprint with the associated ID.

5. The device of claim 4, wherein the control component is further configured to compare the voice fingerprint with previously stored voice fingerprints of other participants of the conference call.

6. The device of claim 5, wherein the control component is further configured to change a category position of at least one of the other participants upon comparison of the voice fingerprint of the currently speaking participant to the previously stored voice fingerprint of the at least one other participant.

7. The device of claim 5, wherein the control component is further configured to swap category positions of the currently speaking participant and at least one of the other participants upon comparison of the voice fingerprint of the currently speaking participant to the previously stored voice fingerprint of the at least one other participant.

8. The device of claim 1, wherein the speech analysis component is further configured to determine the voice fingerprint based upon a voice pitch in the speech frames.

9. The device of claim 1, wherein the determined category position is an end category position and the audio engine is further configured to output the audio signals based upon a first category position for a first determined period of time and then to output the audio signals based upon the end category position.

10. The device of claim 9, wherein the audio engine is further configured to output the audio signals based upon a third category position for a second predetermined period of time.

11. The device of claim 9, wherein the end category position is based upon a determination that the voice fingerprint of the currently speaking participant is similar to a previously stored voice fingerprint of another participant of the conference call.

12. The device of claim 11, wherein the end category position and the category position of the another participant are positioned in the 3D audio space at predefined different positions.

13. The device of claim 1, wherein the device is a Push-to-Talk over Cellular (PoC) device.

14. A method for outputting audio of a conference call in a three dimensional (3D) audio space, the method comprising steps of:
extracting speech frames of a currently speaking participant from a transmission signal; determining a voice fingerprint of the currently speaking participant from the speech frames;
determining a category position of the currently speaking participant in the 3D audio space based upon the voice fingerprint; and
outputting audio signals of the speech frames based upon the determined category position of the currently speaking participant.

15. The method of claim 14, further comprising steps of:
extracting an identification (ID) of the currently speaking participant from the transmission signal;
associating the voice fingerprint with the ID; and
storing the voice fingerprint with the associated ID.

16. The method of claim 15, further comprising a step of comparing the voice fingerprint with previously stored voice fingerprints of other participants of the conference call.

17. The method of claim 16, further comprising a step of changing a category position of at least one of the other participants upon comparison of the voice fingerprint of the currently speaking participant to the previously stored voice fingerprint of the at least one other participant.

18. The method of claim 17, further comprising a step of swapping category positions of the currently speaking participant and at least one of the other participants upon comparison of the voice fingerprint of the currently speaking participant to the previously stored voice fingerprint of the at least one other participant.

19. The method of claim 14, wherein the step of determining a voice fingerprint includes determining the voice fingerprint based upon a voice pitch in the speech frames.

20. The method of claim 14, wherein the determined category position is an end category position and the step of outputting includes outputting the audio signals based upon a first category position for a first determined period of time and then outputting the audio signals based upon the end category position.

21. The method of claim 20, wherein the step of outputting further includes outputting the audio signals based upon a third category position for a second predetermined period of time.

22. The method of claim 20, wherein the end category position is based upon determining that the voice fingerprint of the currently speaking participant is similar to a previously stored voice fingerprint of another participant of the conference call.

23. The method of claim 22, wherein the end category position and the category position of the another participant are positioned in the 3D audio space at predefined different positions.

24. A method for positioning participants of a conference call in a three dimensional (3D) audio space, the method comprising steps of:
positioning a first participant of the conference call in a first category position of the 3D audio space based upon a voice fingerprint of the first participant;
outputting audio of the first participant at the first category position;
identifying a second participant in the conference call;
comparing the voice fingerprint of the first participant to a voice fingerprint of the second participant;
determining whether to change the category position of the first participant based upon the comparison;
positioning the second participant in a category position of the 3D audio space; and
outputting audio of the second participant at a category position different from the first participant based upon the determination.

25. The method of claim 24, wherein the step of comparing includes comparing a pitch value of the voice fingerprint of the first participant to a pitch value of the voice fingerprint of the second participant.

26. The method of claim 25, further comprising steps of:
changing the category position of the first participant to a second category position; and
outputting audio of the first participant at the second category position.

27. The method of claim 26, wherein the category position of the second participant is the first category position.

28. The method of claim 24, further comprising a step of swapping the category position of the first participant and the second participant.

29. The method of claim 28, further comprising a step of outputting audio of the first participant at a second category position.

30. The method of claim 24 further including steps of:
positioning a third participant in a category position of the 3D audio space different from the category position of the first and second participants;
positioning a fourth participant in a category position of the 3D audio space different from the category position of the first, second, and third participants;
positioning a fifth participant in a category position of the 3D audio space different from the category position of the first, second, third, and fourth participants;
comparing a voice fingerprint of a sixth participant to the voice fingerprints of the first, second, third, fourth, and fifth participants; and
positioning the sixth participant in a category position of the 3D audio space with another participant based upon the comparing step of the voice fingerprint of the sixth participant, wherein the 3D audio space includes five category positions of far-left, front-left, front, front-right, and far-right.

31. The method of claim 30, wherein the step of positioning the sixth participant is based upon determining which voice fingerprint is most dissimilar to the voice fingerprint of the sixth participant.

32. A computer readable medium storing computer readable instructions that, when executed, performs a method for positioning participants of a conference call in a three dimensional (3D) audio space, the method comprising steps of:
a client component configured to extract speech frames of a currently speaking participant from a transmission signal;
a speech analysis component configured to determine a voice fingerprint of the currently speaking participant from the speech frames;
a control component configured to determine a category position of the currently speaking participant in the 3D audio space based upon the voice fingerprint; and
an audio engine configured to process and output audio signals of the speech frames based upon the determined category position of the currently speaking participant.

33. The computer readable medium of claim 32, wherein the client component is further configured to extract an identification (ID) of the currently speaking participant from the transmission signal.

34. An apparatus for positioning participants of a conference call in an audio space, comprising:
means for extracting speech frames of a currently speaking participant from a transmission signal;
means for determining a voice fingerprint of the currently speaking participant from the speech frames;
means for determining a category position of the currently speaking participant in the 3D audio space based upon the voice fingerprint; and
means for processing and outputting audio signals of the speech frames based upon the determined category position of the currently speaking participant.

35. The apparatus of claim 34, wherein the means for extracting speech frames of a currently speaking participant from a transmission signal includes a client component.
